(19) United States
(12) Patent Application Publication
(10) Pub. No.: US 2012/0140085 A1
(43) Pub. Date: Jun. 7, 2012

(54) CAMERAS, CAMERA APPARATUSES, AND METHODS OF USING SAME

(76) Inventors: Gregory David Gallinat, Los Gatos, CA (US); Linda Rheinstein, Sherman Oaks, CA (US)

(21) Appl. No.: 13/377,531

(22) PCT Filed: Jun. 9, 2010
(86) PCT No.: PCT/US10/38055

§ 371 Date: Feb. 22, 2012

Related U.S. Application Data
(60) Provisional application No. 61/185,199, filed on Jun. 9, 2009.

(51) Int. Cl. H04N 5/225

(52) U.S. Cl. 348/207.1; 348/E05.024

(57) ABSTRACT

The present specification provides hands-free, mobile, real-time video cameras that overcome the shortcomings of previous designs. Cameras described in the present specification may be light-weight and small enough to be mounted anywhere, especially on a user's body. Cameras described in the present specification may be also cost-effective and rugged enough for use during very strenuous and/or high contact activities. Yet, even with a very small and durable form-factor, cameras described in the present specification offer full-motion, enhanced, and/or high-definition video capture over an extended period of time. The combination of diminutive size, low-power consumption, and high resolution has been heretofore unavailable in the art. Moreover, cameras described in the present specification may be seamlessly compatible with various software applications and platform independent.

### BACKGROUND

1. Field

This disclosure relates to devices and methods for generating, processing, transmitting, and displaying images, either locally or remotely. This disclosure relates to devices and methods for monitoring a specific location, function, or event, such as a sporting event. The devices of the present disclosure may be concealed, portable, or comprise plural cameras.

2. Prior Art

Everyone wants to feel like they are in the middle of the action. Action sports spectators are particularly drawn to images from the player's point of view—seeing through their eyes. Of course, such an intimate viewpoint might be compelling in numerous situations to many types of viewers, parents, video artists, behavioral scientists, advertisers, etc.

For example, during the NFL World Football League playoff and championship game in Europe of 2000, cameras were mounted in the player's helmets and referee's caps. U.S. Pat. No. 6,819,354 provides a helmet-mounted camera. Likewise, U.S. Pat. No. 6,704,044 provides a camera mounted to a baseball-style cap.

Although the helmet and cap mounted cameras were of great interest to the spectators (including the professional announcers), those cameras suffered from several insurmountable problems. First, the battery packs were relative large and mounted inside the helmet or cap. The mounting location, coupled with the weight of the battery pack, was uncomfortable and dangerous for the players. Second, the picture quality was nominal because the lighting inside the stadium was constantly changing and the image would rapidly lighten or darken as the angle of the helmet changed with the viewpoint of the player. In addition, the nature of the player movement caused jumpiness in the image. Finally, the wireless transmission and NTSC signal encroached on the frequencies of the other wireless systems already in place.

### SUMMARY

The present specification provides hands-free, mobile, real-time video cameras that overcome the shortcomings of previous designs. Cameras described in the present specification may be light-weight and small enough to be mounted anywhere, especially on a user's body. Cameras described in the present specification may be also cost-effective and rugged enough for use during very strenuous and/or high contact, semi- or full collision activities. Strenuous activities can be defined by perceived exertion, for example, according to the Borg RPE Scale. High contact, semi- or full collision activities can be defined by the American Academy of Pediatrics

Yet, even with a very small and durable form-factor, cameras described in the present specification offer full-motion, enhanced, and/or high-definition video capture over an extended period of time. The combination of diminutive size, low-power consumption, and high resolution has been heretofore unavailable in the art.

Moreover, cameras described in the present specification may be seamlessly compatible with various software applications and platform independent.

### BRIEF DESCRIPTION OF THE DRAWINGS

FIG. 1 is a diagram of the modules of a camera according to the present specification.

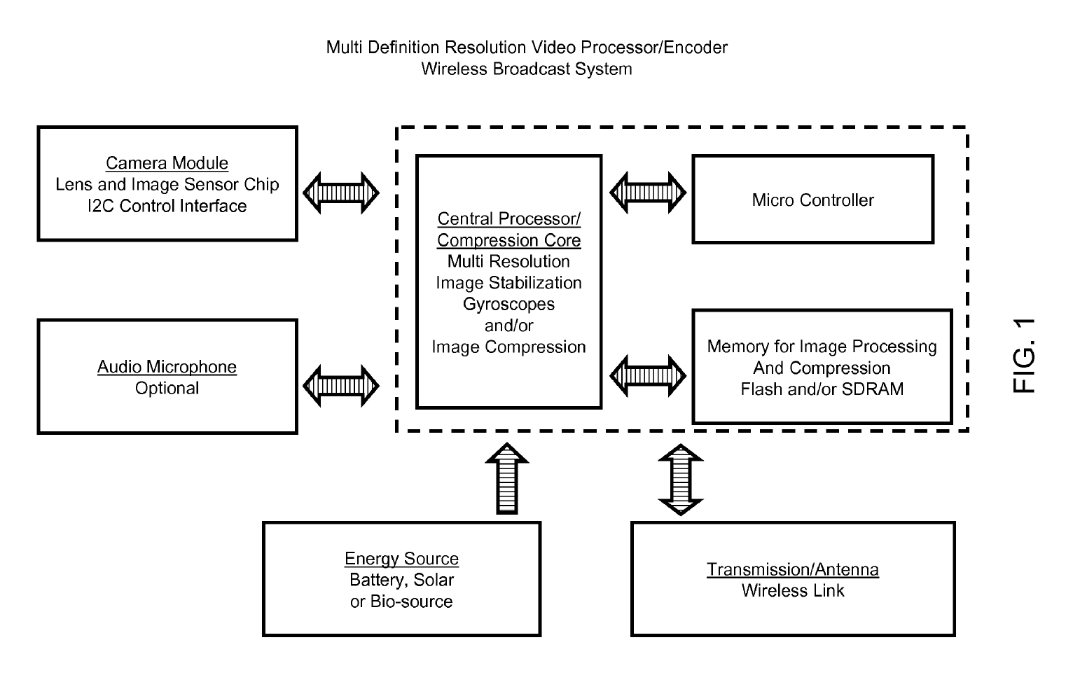

### DETAILED DESCRIPTION

Any reference to light or optical devices may contemplate any type of electromagnetic radiation of any frequency and wavelength, including and not limited to visible, infrared, and ultraviolet light. For example, the term “sensor” may include any device that converts at least one type of electromagnetic radiation to an electric signal. Nonetheless, the term “sensor” may be preferably limited devices that convert visible light to an electrical signal.

“Real-time” means without intentional delay, given the features of the camera and camera apparatuses described herein, including the time required to accurately receive, process, and transmit image data.

The present specification describes cameras, external and/or remote interfaces for cameras, and camera apparatuses.

Cameras according to the present specification may include a sensor module, a processing module, a communication module, a power supply, and a mount. As described in further detail herein below, the modules of the cameras according to the present specification may also be themselves modular or customizable. Moreover, the modules of the cameras according to the present specification may be integrated, separate, or separable.

1. Sensor Module

The sensor module is adapted to receive at least one type electromagnetic radiation and produce an output signal related to the received electromagnetic radiation.

The sensor module comprises a sensor and, optionally, other optical devices including and not limited to at least one lens, a waveguide (e.g., optical fiber), an optical and/or mechanical image stabilizer, and/or a protective cover (e.g. a pull-tab lens cover). The sensor may be, for example, a charge coupled device (CCD) or a complementary metal-oxide-semiconductor (CMOS) active-pixel sensor.

As will be understood by one skilled in the art, the sensor module may be automatically or user-selectably controlled for different focal lengths, lighting conditions, or other camera and video performance features. In addition, different lens configurations may be employed, such as wide angle, fish eye, miniature, and/or zoom. In particular, the sensor module may comprise a solid state auto-focus mechanism.

The sensor module may comprise an optical, and/or electrical, and/or mechanical image stabilizer. An optical image stabilizer as part of the sensor module could be implemented in front of the sensor, e.g., by a floating lens element that may be moved relative to the optical axis of the lens using at least one actuator, such as an electromagnet. Vibration could be detected using piezoelectric angular velocity sensors (often called gyroscopic sensors). Alternatively, an electrical image stabilizer could be incorporated into the software processing portion of the image sensor and/or the processor module itself. Alternatively, a mechanical image stabilizer as part of the image sensor module could be implemented by moving the sensor itself. Like an optical image stabilizer, a mechanical image stabilizer may employ gyroscopic sensors to encode information to at least one actuator, such an electromagnet, that moves the sensor. It could also employ dedicated gyroscopic sensors which provide acceleration and/or movement data to aid in calculations to stabilize the image detected

Resolutions that may be output from the sensor include and are not limited to NTSC, 480p (i.e., VGA 640×480), PAL, 525p, HDTV, 720p (i.e., 1280×720 pixels), 1080p, and 1080i. The sensor may be capable of variable output, i.e., automatically or user selectively sending more or less data to the processor. For example, a variable output sensor is described in U.S. Pat. No. 5,262,871, which is incorporated by reference herein in its entirety.

The image sensor module may be, for example, a High Definition 720p or 1080p Camera Module that may be about 7 mm by 7 mm by 6 mm (x by y by z) in size including the lens. The image sensor may also be an Enhanced Definition 480p Camera Module (VGA may be 640×480 square pixels). Major manufacturers from which such image sensor modules may be available include OmniVision (e.g., native HD sensors), Samsung, and Sony.

A preferred sensor module comprises support for YUV, combined RGB, and raw RGB output formats, parallel DVP output interface, automatic exposure/gain, horizontal and vertical windowing capability, auto white balance control, aperture/gamma correction, serial camera control bus for register programming, external frame sync capability, flicker cancellation, defective pixel correction, a power requirement of less than about 600 mW, an input clock frequency of about 5 to about 30 Mhz, progressive scan mode, rolling shutter, 30 fps full resolution, at least about 5 V sensitivity (lux-sec), at least about 100 dB dynamic range, and pixel size less than 5 μm.

The sensor module may be optionally adapted to receive at least one type of mechanical vibration (e.g., sound, ultrasound, and/or infrasound) and produce an output signal related to the received mechanical wave. In other words, the sensor module may include a microphone.

2. Processing Module

The data output from the sensor module may be provided to a processing module. The image processing module preferably provides highly integrated, fully compliant encoding, decoding, pre-processing, and post-processing. In short, the image processing module may be a system-on-a-chip and its potential features may be limited only by the constraints of weight, size, and power consumption.

Hardware or software enabled features of the image processing module may include: a high, main, and baseline H.264 HD1920×1080i codec; an HD1920×1080i MPEG2 decoder; a MJPEG codec (up to 12 MP); multiple audio formats, such as, for example, AAC, G.7xx, AMR, MP1/2/3, and Dolby; dual, high-profile 720p30; multichannel 8 D1 or 16 CIF; 720p30 full-duplex operation; 1920×1080i MPEG2 to H.264 transcoding; AES and SHA hardware assist; motion adaptive de-interlacing and noise reduction; temporal/spatial filters; video cropping, scaling, and compositing; frame- and bit-rate control; advanced edge preservation; image stabilization, which feature may employ gyroscopes or other positioning and/or acceleration detection capability; multiple inputs and outputs; time and/or date coding; and/or a GPS locator, which may communicate with satellite and/or terrestrial GPS transmitter for highly accurate tracking (e.g., within a playing field and among numerous other wireless signals).

The image processing module may provide high dynamic range (HDR) imaging. Exposure bracketing may be used to achieve HDR. Tone mapping techniques, which reduce overall contrast to facilitate display of HDR images on devices with lower dynamic range, can be applied to produce images with preserved or exaggerated local contrast for artistic effect.

The Image Processing Module may comprise integrated and/or removable image storage. For example, the image processing module may comprise on-board video memory that may be exportable for viewing and processing with an external and/or remote interface.

Notably, the image processing module may be the size of a small pack of matches and consume less then 1 watt of power. The image processing module may be about 20 mm by 20 mm in size.

Suitable processing modules may be available from Maxim Integrated Products, Inc., Texas Instruments, Inc. (e.g., OMAP), Xilinx® (e.g., Spartan® FPGA), and Freescale Semiconductor Inc. (e.g., i.MX multimedia applications processors).

A preferred processing module comprises an 800 MHz CPU with 32 KB instruction and data caches, unified L2 cache, SIMD media accelerator, and vector floating point co-processor. A preferred processing module further comprises a multi-format HD720p encoder, a HD720p video decoder and D1 video encoder hardware engine, 24-bit primary display support up to WXGA resolution, 18-bit secondary display support, analog HD720p component TV output, hardware video de-interlacing, image and video resize, inversion and rotation hardware, alpha blending and color space conversion, color correction, gamut mapping, and gamma correction. A preferred processing module also comprises an external memory interface for mDDR and DDR2 SDRAM, and SLC/MLC NAND flash memory.

3. Communication Module

The processed data output from the processing module may be provided to a communication module for transmission to an external and/or remote receiver. The communication module may also receive input from an external and/or remote transmitter, such as, for example, signals for controlling the sensor module and/or processing module. Communication may be wired or wireless. The communication module may be preferably a complete client device comprising an integrated media access controller (MAC), baseband processor, transceiver, and amplifier.

Hardware or software enabled features of the communication module may include: compliance to IEEE 802.11b/g and single or multiple stream IEEE 802.11n; compliance to WiMAX (e.g., IEEE 802.16e “mobile WiMAX”); a host interface through SDIO and SPI; bluetooth coexistence; ultra low power operation; complete WLAN software along with a host driver for Windows; embedded CE, windows Mobile, windows XP, Linux, iPhone, Mac and/or Google Android OS; single supply 3.0 to 3.6 V operation; robust multipath performance and extended range using STBC; and a small footprint.

The communication module may be adapted for a wireless transmission environment that may be entirely scalable and able to support multiple mobile camera feeds or placed on fixed locations (e.g., goal line markers or goal nets). For example, in a sporting environment, the access point receivers may be placed virtually anywhere inside a field and/or stadium to provide live action feeds from anywhere on the field. In fact, players may carry wireless transmission booster packs to increase signal strength for transmission to the sideline. For another example, cameras described in present specification may be remotely utilized (e.g., controlled and/or viewed) via a mobile telephone/smart phone, laptop computer, or other wireless or wired display (LCD) capable viewing and/or control interface.

The communication module may be about 20 mm by 30 mm in size. Suitable communication modules may be available from Redpine Signals, Inc. A preferred communications module is a complete IEEE 802.11bgn Wi-Fi client device with a standard serial or SPI interface to a host processor or data source. It integrates a MAC, baseband processor, RF transceiver with power amplifier, a frequency reference, an antenna, and all WLAN protocol and configuration functionality in embedded firmware to provide a self-contained 802.11n WLAN solution.

4. Power Supply

The compact and portable nature of the cameras described in the present specification lends itself to the use of equally compact and portable power supplies, i.e., batteries.

As will be understood by one skilled in the art, the power supply may be selected by balancing various parameters including and not limited to the size, weight, and capacity of the power supply versus the size, weight, and efficiency of the other camera modules. For example, a suitable battery for cameras according to the present specification may provide power for at least about an hour (and preferably two hours or more) and be about 20 mm in diameter and weight about 5 grams.

The power supply may be disposable or rechargeable. Also, the power supply may comprise an alternative energy source, such as, for example, a power generator powered by solar energy or kinetic energy (i.e., power from the user's body motion or body heat).

Suitable power supplies include and may be not limited to lithium ion batteries, nickel metal hydride batteries, and alkaline batteries.

Alternatively, the power supply may rely on wireless energy transfer, such as, for example, induction, and/or printed electronics techniques, such as, for example, flexible polymer batteries.

A light sensitive on/off switch may be utilized to conserve power while allowing for a quick transition from low-power standby mode (also known as “sleep mode”) to full-power operation. The image sensor chip may include at least one pixel that is always “on,” i.e., always held within an operational voltage range. The always-on pixel may be located in the test pixel area. While the lens is covered, the camera can be in standby or sleep mode. Once the cover is removed, the always-on pixel detects light entering the lens, and the camera returns to full-power operation.

5. Mount

Cameras according to the present specification may incorporate a mount removeably attachable to a user or an object. For example, by using a reusable, pressure sensitive adhesive, a camera according to the present specification may be reversibly mounted on a wall, a goal post, or even a helmet (just like a postage stamp).

6. External and/or Remote Interface

To make them as small as practicable, cameras according to the present specification may not have a display, which might require an inconvenient amount of both space and power. Also, cameras according to the present specification may not have built-in control interfaces to operate various system parameters. In fact, by utilizing the sensor, processing, and communication modules described herein above, cameras according to the present invention may have only an on/off switch (or no switches at all); all other control features being available through an external and/or remote interface. The external and/or remote interface may also provide further processing subsequent to transmission.

Features of the external and/or remote interface may include: single and multiple camera control and synchronization; software for image and audio processing; mobile phone/smart phone compatibility.

7. Operation

In operation, the sensor module of a camera according to the present specification receives light through a lens that focuses the light onto a sensor. The light causes a voltage change within the pixel structure of the sensor. This voltage change may be detected and, by having the sensor pixel structure arranged in an array pattern, an image may be built from each individual pixel voltage level change.

Once captured, the image data may be transferred to the processing module in which video processing occurs that may, for example, construct a video stream and/or improve the image quality. Image stabilization may occur either in the camera module depending on the capabilities of the camera module, in the central processor, or in an external and/or remote interface. The image stabilization process may use data obtained from gyroscopes or other acceleration/positioning detection technology incorporated within the camera. The processed image data may be then compressed using MPEG-4, Motion-JPEG, or various other video compression techniques.

The processed image data may be sent to the communications module where the image data may be formatted for wireless broadcast. Wireless broadcast may be via 802.11n, or WiMax, or another wireless transmission capability. Control features and functions may be controlled via an external and/or remote wired or wireless interface, such as a laptop computer, smart phone, or other wireless device with an image display or projection capability. The processed image data could also be stored within the camera itself, in a dedicated memory location.

The wireless video broadcast may be a user selectable between different target reception devices. User control may select a single reception device such as a laptop computer, smart phone, or other video display device to receive and/or decrypt the video image. The user control may enable select multiple reception devices, such as, for example, a group of devices or user defined specific devices to be allowed to receive and/or decrypt the video data. The user control may select a broadcast which allows any device within range to receive the video data. Video broadcast data may be encrypted to ensure privacy of the video data.

The video capture and display function may be partially performed by having the video data stored by the camera on a optional memory device for processing and playback later in an external and/or remote display device such as laptop, smart phone, or other display device.

In addition, the video capture and display function may be partially performed by having the video data stored by a first external and/or remote interface for processing and playback later in a second external and/or remote display device such as laptop, smart phone, or other display device. For example, the video data may be stored on a video hosting server for processing and/or playback later in a web-based interface.

On-camera or external processing may include combining real image data from the camera with virtual image data to create a composite image. For example, real image data of a user may be combined with virtual image data of a background to create a combined image of a user in a location that the user did not visit.

On-camera or external processing may include using real image data from the camera to create or paint virtual images. For example, real image data of a user may be used to paint a virtual image of the user (i.e., an avatar).

As an option, cameras according to the present specification may provide a single control point user interface. For example, upon initialization, a camera may broadcast a handshake protocol request and wait for a reply from a wireless transmission video display device. Using an external and/or remote interface, a user would reply to the camera's handshake request enabling the user's interface to be the only recognized control point for accessing the camera. A single point user interface allows the individual user to control the user interface options available on the camera, such as, for example, lighting controls, selectable compression techniques and algorithms, broadcast type (single point, select group, or worldwide), power modes, such as, for example, on/off or sleep, continuous or intermittent video image capture and/or broadcast, or other camera performance capabilities.

Optionally, multiple cameras could be controlled by a single external and/or remote user interfaces. Optionally, a single camera could be controlled by multiple external and/or remote user interfaces. Optionally, multiple cameras could be controlled by multiple external and/or remote user interfaces. Optionally, an external interface (i.e., control device) may be plugged into a mini-USB or other electronic communication socket on the camera to provide a direct cable-link for initial configuration or subsequent communication with the camera.

Practically, the design of cameras according to the present invention requires the careful balancing of processing and communication power usage versus energy supply (and price). For example, all data generated by the camera (e.g., gyroscope and accelerometer data along with video and timecode) may be communicated to the external and/or remote interface. However, a sustainable, clean signal (i.e., acceptable communication using the least amount of power) may compromise the goal of a smooth image (i.e., highly processed or processable data). In other words, boosting power to the transceiver may allow for a more accurate communication between the camera and the remote interface, but at the expense of being able to perform image stabilization in the processing module. Each application, e.g., a professional sporting event or a small family picnic, requires a different balance and a different combination of modules. The miniaturized and modular cameras described herein are well adapted for achieving the right balance.

8. Camera Apparatuses

Camera apparatuses according to the present specification include at least one camera as described herein above in combination with markers that are employed for enhanced video processing, such as, for example, enhanced image stabilization and enhanced image tracking. Camera apparatuses according to the present specification including markers are even capable of producing data for a 3-D display. Enhancing the capture for use with 3-D display could also include two or more cameras.

The markers may be passive (such as, for example, paint, ink, chalk, or a reflective surface) or active (such as, for example, radio transmitters or LEDs). Markers may be located or defined upon persons and objects that are within an area of interest or that will pass through an area of interest. For example, if a football field is the area of interest, marker(s) may be located or defined on all the player's helmets, caps, jerseys, uniforms, shoulder pads, hip pads, gloves, shoes, hands, and feet, as well as on sidelines, goal lines, and even the ball. Markers may be pre-determined or dynamically defined and be of any shape and size. For example, regarding a ball, a marker may be defined as the laces, as a stripe applied to the ball, or as either of the laces or the stripe depending upon which marker is visible to a camera in a scene.

Cameras and external interfaces according to the present specification can receive and transmit more data using less power if the processing module (or external interface) can process data faster and more accurately. For example, using one or more techniques for enhancing edge detection/determination allows the processing of each a frame of data to be faster and more accurate.

To process edge definitions faster and more accurately, colors that have a higher contrast ratio may be used. For example, with dynamic action on a relatively static background (e.g., a football game on green field or a skiing competition on white slope), having an individual in a highly contrasting color allows the processing module (or Page 15 of 23 external interface) to better determine lines, shapes, and edges (e.g., a white jersey against the green field, or a red ski jacket against the white slope).

In addition, patterns of markers may also be used to process edge definitions faster and more accurately. For example, using easily defined patterns of markers (e.g., dots, squares, or diamonds) allows the processing module (or external interface) to better determine lines, shapes, and edges. If a pre-determined pattern of markers is defined or applied to a specific location (e.g., numbers on a jersey, diamonds on a helmet, or stripes on shoes), this allow for better detection and deterministic calculation, which better defines the scene.

Active markers many emit a signal in continuous, random, or controlled patterns. Controlled pattern could include intelligent information such as velocity, acceleration, and/or, more biological information of the wearer (e.g., heart beat or body temperature). For example, an LED can be pulsed depending on the action or activity of the player. Faster pulses could be from speed, acceleration, or other physical attributes. The control of the LEDs can be both from on-player sensors such as G-force or accelerometers, and from remote determination. The LED emission can be in the visible, infra-red, and/or ultra-violet spectrum.

Several edge-enhancement techniques may be utilized simultaneously and each technique may be employed in numerous schemes. For example, the front of a jersey may be red with blue dots and the back of the jersey may be blue with red dots. Then, the processing module (or external interface) could determine which direction the player is facing with minimal processing.

Image data from a camera may be received and processed by an external and/or remote interface together with processing data (e.g., timecode, and gyroscope and accelerometer data) received from that camera, as well as tracking data based on the markers (received by the external and/or remote interface either within the image data from the camera or from an active marker). Thereby, the image data may be stabilized based on both the processing data and the tracking data.

Color and/or time vector analysis based on tracking data may be performed with or without processing data. For example, a color/time vector may track a “video paint” through an area of interest for wireless signal detection. In the context of a football game, color and/or time vector analysis based on tracking data allows individual players to be tracked within a scene. Such tracking might allow for having a player's helmet camera turn-on depending on if the player is determined as “in the play” or not. Directors and/or computers could provide real-time update/play-by-play for which cameras on the field may be “always-on” or “sometimes-on.”

Employing two cameras as part of a camera apparatus according to the present invention may be the basis for 3-D image capture and display. Each individual camera creates a video vector to a target image (e.g., a football). Using two video vectors slightly displaced from one another, software processing may create a 3D image. Parallax errors may be introduced within the image scene due to the two camera having slightly different views of the target. By using the known distance between the cameras, and the distance to the target (and/or the change in the distance to the target), the parallax errors may be processed out of the final image.

Static markers provide a fixed reference plane. Dynamic markers (i.e., markers on moving objects including players) may be imaged to increase accuracy of field location alignment for re-construction of an entire scene. Building frame-to-frame video and outlining the individual players using software tools similar to Adobe® Illustrator® or Photoshop®, the player may be accurately placed into the 3-D field (e.g., an X,Y,Z reference Cartesian coordinate system space). By timecoding the video stream, each frame of video data may be accurately placed into 4-D space (e.g., time plus an X,Y,Z reference Cartesian coordinate system space). Optionally, multiple cameras may have a constant timecode, which allows for a more accurate recreation of the entire scene).

In addition to the two initial video vectors, other cameras within the same field provide additional video vectors. Knowing the video vector from each camera allows for processing parallax removal, which helps increase the depth of the 3-D field. Also, the additional video vectors may be used sharpen the primary 3D image.

Moreover, processing data including gyroscope and accelerometer data from the cameras provides the possibility of video image processing using digital data plus external sensor inputs for position and movement parameters, which affords an enhanced ability to re-create 3-D video via the best resolution possible, plus added dynamic & static information on position, alignment, acceleration, and shock.

What is claimed is:

1. A video camera comprising a sensor module adapted to output 720p, 1080p, or 1080i resolution video, a processing module adapted to process at least 8 bit raw RGB data, a communication module adapted to wirelessly transmit in compliance with at least one IEEE 802.11 standard, a power supply adapted to power the video camera for at least about one hour, a mount removeably attachable to a user or an object, an optional microphone, and at least one optional remote interface.

2. The camera of claim 1, wherein the sensor module comprises at least one lens, a waveguide, an optical and/or mechanical image stabilizer, or a protective cover.

3. The camera of claim 1, wherein the sensor module comprises a charge coupled device (CCD) or a complementary metal-oxide-semiconductor (CMOS) active-pixel sensor.

4. The camera of claim 1, wherein the sensor module comprises an optical, electrical, or mechanical image stabilizer.

5. The camera of claim 1, wherein the processing module comprises integrated or removable image storage.

6. The camera of claim 1, wherein the processing module comprises integrated or removable image storage or memory.

7. The camera of claim 1, wherein the power supply comprises solar energy or kinetic energy power generator.

8. The camera of claim 1, comprising a light sensitive on/off switch comprising at least one pixel that is always held within an operational voltage range.

9. The camera of claim 1, wherein the remote interface is a mobile telephone, whereby the camera is controllable and viewable remotely.

10. The camera of claim 1, wherein the sensor module is about 7 mm by 7 mm by 6 mm in the x, y, and z dimensions respectively; the image processing module is about 20 mm by 20 mm in size; and the communication module is about 20 mm by 30 mm in size.

11. The camera of claim 1 adapted for use during very strenuous or high contact activities.

12. A method of providing high definition video from a camera comprising the step of: providing at least one video camera comprising a sensor module adapted to output 720p, 1080p, or 1080i resolution video, a processing module adapted to process at least 8 bit raw RGB data, a communication module adapted to wirelessly transmit in compliance with at least one IEEE 802.11 standard, a power supply adapted to power the video camera for at least about one hour, a mount removeably attachable to a user or an object, an optional microphone, and at least one optional remote interface.

13. The method of claim 11, wherein the remote interface is a mobile telephone, whereby the camera is controllable and viewable remotely.

14. The method of claim 11, wherein multiple cameras are controllable by a single remote interfaces or a single camera is controllable by multiple remote interfaces.

15. A camera apparatus comprising:
at least one video camera comprising a sensor module adapted to output 720p, 1080p, or 1080i resolution video, a processing module adapted to process at least 8 bit raw RGB data, a communication module adapted to wirelessly transmit in compliance with at least one IEEE 802.11 standard, a power supply adapted to power the video camera for at least about one hour, a mount removeably attachable to a user or an object, an optional microphone, and an optional remote interface;
markers that are adapted to enhance video processing by the video camera; and
an optional external interface adapted to process video data from the video camera.

16. The camera apparatus of claim 15, wherein the markers are passive or active, and static or dynamic.

17. The camera apparatus of claim 15, wherein the markers are active markers adapted to emit a signal in continuous, random, or controlled patterns, whereby the controlled pattern optionally includes information of the wearer.

18. The camera apparatus of claim 15, wherein the markers are dynamic markers adapted to be imaged to increase accuracy of field location alignment for re-construction of an entire scene.

19. The camera apparatus of claim 15 comprising two video cameras adapted for 3-D image capture and display.

20. The camera apparatus of claim 15 comprising two cameras adapted to process parallax removal, whereby the depth of a resulting 3-D field is increased.
